(19) United States
(12) Patent Application Publication
(10) Pub. No.: US 2004/0158344 A1
(43) Pub. Date: Aug. 12, 2004

(54) Mask management device in semiconductor wafer production process

(75) Inventors: Takamasa Inobe, Hyogo (JP); Masaki Ootani, Hyogo (JP); Yasuhiro Sato, Hyogo (JP); Yasuhiro Marume, Hyogo (JP); Toshiyuki Watanabe, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/655,039

(22) Filed: Sep. 5, 2003

(30) Foreign Application Priority Data
Feb. 7, 2003 (JP) 2003-030967(P)

(51) Int. Cl. G06F 19/00

(52) U.S. Cl. 700/121

(57) ABSTRACT

A wafer production management device includes: a process flow definition table storing for each type of wafer a production flow and a masking level applied in a production process; a basic production information table storing a mask set's name for each type of wafer; a mask information definition table storing for each mask set a plurality of masks' names correlated with a masking level; a lot information table storing a production flow and a type of wafer for each production lot; a processing portion selecting from the basic production information table a mask set's name corresponding to a type of wafer stored for each production lot; a processing portion extracting a masking level based on the current step and the process flow definition table; and a processing portion driven by the mask set's name and the masking level to select a mask's name from the mask information definition table.

### BACKGROUND OF THE INVENTION

1. Field of the Invention

The present invention relates generally to management technology in semiconductor wafer production lines and particularly to mask management technology in wafer processing processes.

2. Description of the Background Art

Conventionally there has been produced an integrated circuit (IC) chip including a circuit having an interconnection pattern changed to meet specifications required by customers. Such an IC chip is produced in an IC chip production process including a wafer processing process using as an original a mask forming a shading pattern formed of thin metal film on a synthetic quartz substrate.

Such an IC chip is produced in a production process which is diverse and also includes a wafer processing process (a lithography process including resist application, exposure and development steps in particular) or a similar repetitive process. Accordingly, dissimilar to only several steps of machining that can complete a component of a mechanism, there are several hundreds items for a procedure and a condition for production, and the repetitive wafer processing process employs a jig or mask, which is changed for each step and each product, resulting in an enormous amount of designated data. As a result, not only do a number of steps of inputting data consume an enormous amount of time but also contribute to clerical errors resulting in defective products.

Japanese Patent Laying-Open No. 7-169662 discloses a production system management method capable of creating production instruction data with a reduced number of steps of inputting data to prevent clerical errors associated with inputting data and resulting in defects. This method includes the steps of: creating a production procedure database formatting process flows each indicative of production procedure data for a product into a plurality of patterns for registration, a production condition database classifying and creating, and registering a name of an apparatus of equipment and a condition for production that are employed and applied, respectively, in each step of the formatted process flows, a jig condition database registering a jig used in a step repeated in the process flow; and, whenever a product code of a semiconductor device to be produced is input, extracting production condition data and jig condition data sequentially from the production condition database and the jig condition database that correspond to the semiconductor device's formatted process flow in the production procedure database, and combining the data to create production instruction data.

In this production system management method there is created a production procedure database formatting process flows each indicative of production procedure data for a product into a plurality of patterns and registering the same as templates. There is created a production condition database classifying and registering a name of an apparatus of equipment and a condition for production that are employed and applied, respectively, in identical steps of these templates. There is created a jig condition database registering a mask designating a mask used in a lithography process included in the production procedure template repetitively performed. Whenever a product code of a semiconductor device to be produced is input, a sequential extraction is effected from the production procedure database, the production condition database and the jig condition database, and a production condition template and a jig condition template that correspond to a template indicative of production procedure data are combined to create production instruction data. In the jig condition database a jig that is finally set is a mask used in a lithography process corresponding to repetitive resist application, exposure and development. As such, a jig condition template is a table indicating the number of a mask to be used in each lithography process. Registration with different databases, as described above, can help to address conventionally unresolved issues of: preventing an error in designating a mask; updating a mask; and providing maintenance and management. This can contribute to a reduced number of steps of manually inputting data and also reduced, associated clerical errors, and also completely prevent defects associated with clerical errors otherwise introduced.

Japanese Patent Laying-Open No. 6-348718 discloses a system in which in connection with a communication tag transmitting from a technology department to a production department a condition for production for each production process its creation and the condition for production are collectively output to allow the condition to readily be managed to address frequent changes in use or design. This system includes: a communication tag database using a communication tag number as a keyword to store a name of an intermediate product of each production step and other conditions for production; a register registering an input condition for production with the communication tag database with a keyword corresponding to a new communication tag number corresponding to an existing communication tag number's maximum value plus one; and a retriever retrieving from the communication tag database a condition for production for an intermediate product's name input that is associated with a largest communication tag number.

In this production condition management system the communication tag database is configured of: a communication form number, or a keyword, uniquely determining contents of a communication tag, such as conditions for production including a creator of the communication tag, a name of the creation, a reason(s) for the creation, an approver, a name of an intermediate product for each production step (e.g., a name of a wafer, a name of a pellet, a name of an IC product and the like); and contents of the communication tag. If in a diffusion step an operator has received an instruction for production to “produce a wafer A” and via a terminal device the wafer's name A is input, for the name a mask's name “QR-1234” is for example displayed on the terminal device. This mask is used in an exposure operation. Thus a communication tag conventionally used to transmit a condition for production at each production step from a technology department to a production department, and a production condition table can be unified to eliminate an overlapping management of conditions for production. This effectively (1) reduces enormous labor required for management of conditions for production, (2) facilitate reference to conditions for production, (3) reduce erroneous transmissions of conditions for production, and (4) reduce the time required to transmit conditions for production.

Japanese Patent Laying-Open No. 2001-85317 discloses a method of producing a semiconductor integrated circuit device which introduces a predetermined distortion in a semiconductor circuit's pattern on a mask, a reticle or a similar original for exposure to ensure that a resist pattern is transferred and formed on a wafer. This method is a method of producing a semiconductor integrated circuit device which employs an exposure apparatus to perform photolithography to transfer on a semiconductor wafer a pattern of an original for exposure, including the steps of: measuring at least one of the pattern's dimensional and positional distortions corresponding to a coordinate of a position of the original for exposure in connection with a distortion associated with transfer that is unique to an individual exposure apparatus; providing a particular original for exposure with a pattern provided with a particular distortion for correction to cancel a distortion associated with transfer that is unique to a particular exposure apparatus; and attaching the particular original to the corresponding, particular exposure apparatus and confirming the same, and transferring the pattern on the semiconductor wafer.

In this method, a mask or a mask case is provided thereon with an identification mark, exposure with a particular reduced-projection exposure apparatus and a particular mask combined together is put to practical use, and a distortion an integrated circuit's pattern transferred that is unique to the exposure apparatus can be reduced. Increased yields of semiconductor integrated circuit devices, and high reliability and performance thereof can be achieved. If in the above case a mask production line and a wafer exposure line (or a mask design and management department) are connected on line, a mask production line's name provided on a mask and a mask's production number can be referred to to specify a combination of an exposure apparatus and a mask.

However, as disclosed in Japanese Patent Laying-Open No. 7-169662, the jig condition template is simply a table indicating the number of a mask to be used for each lithography process. As such, if in some lithography process a mask is changed, the jig condition database and the jig condition template need to be modified. Furthermore, if a single carrier carries multiple lots formed of a plurality of lots, it is difficult to readily select a mask. Furthermore, if the lithography process is performed using a processing apparatus produced by a different maker, it is difficult to use a different mask's name. The system disclosed in Japanese Patent Laying-Open No. 6-348718 and the method disclosed in Japanese Patent Laying-Open No. 2001-85317 also have similar disadvantages.

### SUMMARY OF THE INVENTION

An object of the present invention is to provide a semiconductor wafer production management device capable of readily accommodating changing a mask in a wafer processing process.

Another object of the present invention is to provide a semiconductor wafer production management device capable of readily handling multiple lots in a wafer process.

Still another object of the present invention is to provide a semiconductor wafer production management device capable of readily accommodating processing apparatuses in a wafer process that are manufactured by different makers

The present semiconductor wafer production process management device comprises: a storage portion including a first table storing for each type of semiconductor wafer a process flow for the semiconductor wafer and a first mask identification code identifying a mask used in a masking step included in the process flow, a second table storing for each type of semiconductor wafer a second mask identification code identifying a mask corresponding to the type of semiconductor wafer, a third table storing a plurality of mask information items for each the second mask identification code, and a fourth table storing a process flow and a type of semiconductor wafer for each semiconductor wafer production lot. The third table stores the plurality of mask information items correlated with the first mask identification code capable of identifying the mask information items. The present management device further comprises: a first select portion selecting from the second table the second mask identification code corresponding to a type of semiconductor wafer stored in the fourth table for each the production lot; a detection portion detecting a current process step in the process flow for each the production lot; an extraction portion referring to the first table and driven by the detected current process step to extract a subsequent step and extracting the first mask identification code for the masking step if the subsequent step is a masking step; and a second select portion driven by the second mask identification code selected by the first select portion and the extracted first mask identification code to select the mask information item for the masking step from the third table.

In introducing a semiconductor wafer into a subsequent step the semiconductor wafer's production lot stored in the fourth table is referred to to select the type of the semiconductor wafer and furthermore a second mask identification code corresponding to the type of the semiconductor wafer is selected from the second table. The current process step is detected and a subsequent step based thereon is selected from the first table. If the subsequent step is a masking step then from the first table a first mask identification code is extracted. A mask information item involved in the masking step that is based on the selected second mask identification code and the extracted first mask identification code is selected from the third table. Thus a production management device can be implemented that can more readily than conventional address processes performing the same process steps in the same order, as required by semiconductor wafer production line, and using different types of masks in a masking step. The production management device configured as described above can help a production manager to work dramatically efficiently and it can also sufficiently endure frequent exchanges of masks.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a control block diagram of a computer system implementing a semiconductor wafer production management device of the present invention in a first embodiment;

FIG. 2 shows tables stored in a fixed disk of FIG. 1;

FIG. 3 represents a basic production information table of FIG. 2;

FIG. 4 represents a process flow definition table of FIG. 2;

FIG. 5 represents a mask information definition table of FIG. 2;

FIG. 6 represents a lot information table of FIG. 2;

FIG. 7 is a flow chart illustrating a process effected by the semiconductor wafer production management device of the present invention in the first embodiment;

FIG. 8 shows tables stored to a fixed disk of a computer system implementing the semiconductor wafer production management device of the present invention in a second embodiment;

FIG. 9 represents a process flow definition table of FIG. 8;

FIG. 10 represents a multi-lot information table of FIG. 8;

FIGS. 11-13 represent a lot information table of FIG. 8;

FIG. 14 is a flow chart illustrating a process effected by the semiconductor wafer production management device of the present invention in the second embodiment;

FIG. 15 shows tables stored to a fixed disk of a computer system implementing the semiconductor wafer production management device of the present invention in a third embodiment;

FIG. 16 represents an engaged-mask information table of FIG. 15;

FIG. 17 represents a mask information definition table of FIG. 15; and

FIG. 18 is a flow chart illustrating a process effected by the semiconductor wafer production management device of the present invention in the third embodiment.

### DESCRIPTION OF THE PREFERRED EMBODIMENTS

Hereinafter with reference to the drawings the present invention in embodiments will be described. In the following description and throughout the figures, like components are denoted identically. They are also identical in name and function. While hereinafter a production management device will be described in connection with a semiconductor wafer photography process, the present invention is not limited to the process.

### First Embodiment

The present invention in a first embodiment provides a semiconductor wafer production management device implemented for example by a computer. Hereinafter will be described a computer system corresponding to a specific example for implementing the present semiconductor wafer production management device.

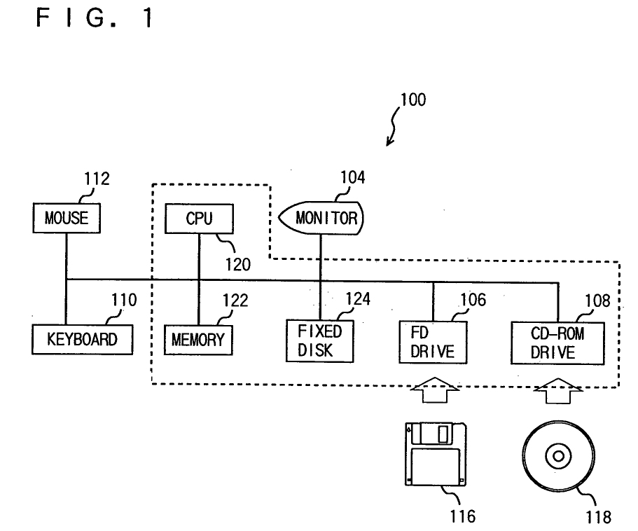

With reference to FIG. 1, a computer system 100 is comprised of a computer 102 including a flexible disk (FD) drive 106 and a compact disc-read only memory (CD-ROM) drive 108 reading and writing data, programs and the like from and to an FD116, a CD-ROM 118 and other similar recording media, a monitor 104 or a similar output device, and keyboard 110, a mouse 112 and other similar input devices.

Computer 102 such as described above includes in addition to FD and CD-ROM drives 106 and 108 as described above a central processing unit (CPU) 120, a memory 112 and a fixed disk 124 interconnected by a bus. FD and CD-ROM drives 106 and 108 receive FD116, CD-ROM 118 and the like.

In the present embodiment the semiconductor wafer production management device is implemented by computer hardware and software (a program) executed by the CPU. Such software is stored in and distributed by FD116, CD-ROM 118 and other similar recording media, and read by FD and CD-ROM drives 106 and 108 and first stored to fix disk 124. The software is further read from fixed disk 124 into memory 122 and executed by CPU 120.

The hardware itself of computer 102 as described above is typical hardware, and the present invention's characteristic feature is implemented by software recorded in FD116, CD-ROM 118, fixed disk 124 and other similar recording media.

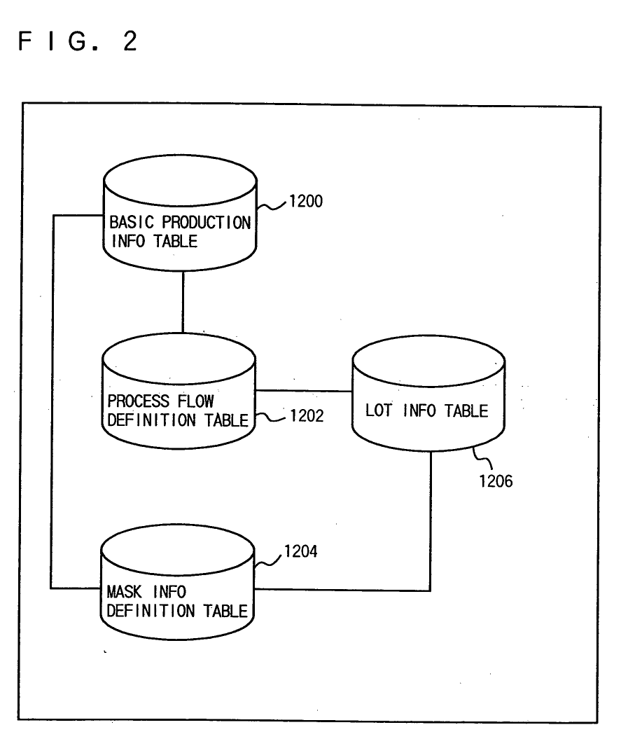

Reference will now be made to FIG. 2 to describe a variety of tables stored in fixed disk 124 of FIG. 1. As shown in the figure, fixed disk 124 stores a basic production information table 1200, table 1202, a mask information definition table 1204, and a lot information table 1206, correlated as shown in FIG. 2.

With reference to FIG. 3, the FIG. 2 basic production information table 1200 will be described. As shown in the figure, basic production information table 1200 stores a mask set's name and a flow's name for each semiconductor chip product's name. For example for a product's name “CHIP100” a mask set's name “MASKSET100” a flow's name “FLOW100” are stored.

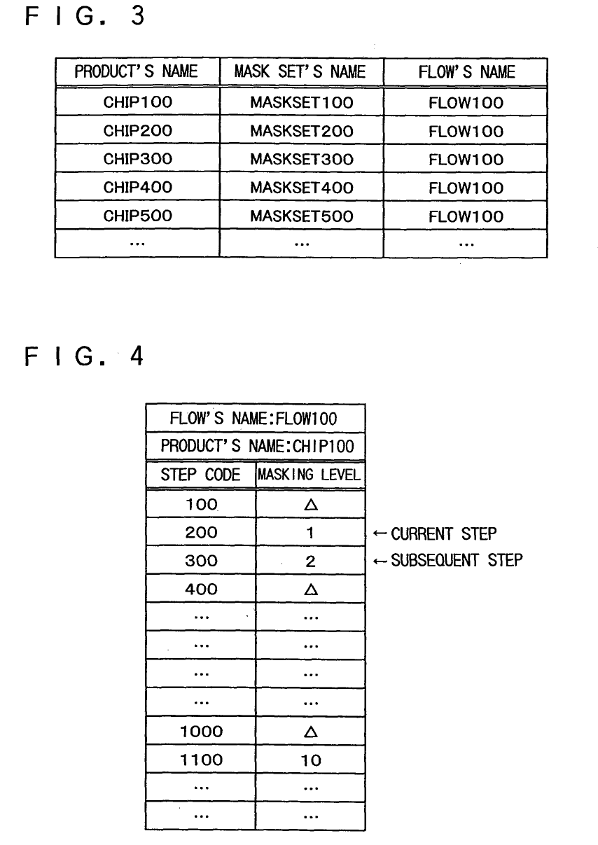

With reference to FIG. 4, the FIG. 2 process flow definition table 1202 will be described. As shown in the figure, table 1202 stores a flow's name and a name of a semiconductor chip product to which the flow is applied. As the flow's name there are stored step codes in a processing order and a masking level for each step code, although a masking level is stored only for a step code representing a photography process step. For example, as shown in FIG. 4, a flow having a name “FLOW100” is applied to a product having a name “CHIP100” and in a processing order, step codes “100,” “200,” “300,” “400,” . . . are stored. Since step codes “200” and “300” are photography process steps and masking levels “1” and “2” are accordingly stored, respectively. According to this process flow definition table, when a flow has the name “FLOW100” and the current step corresponds to step code “200” the subsequent step will be step code “300.”

With reference to FIG. 5, the FIG. 2 mask information definition table 1204 will be described. As shown in the figure, table 1204 stores for each mask set's name a masking level and a name of a mask corresponding to the masking level. For example for a mask set's name “MASKSET100” the table stores a name of a mask corresponding to each of masking levels “1” to “11.” For example, the table stores “MASK1001” as a name of a mask corresponding to masking level “1.” Furthermore, for a mask set's name “MASKSET200” the table stores “MASK2001” and “MASK2002” as names of masks corresponding to masking levels “1” and “2,” respectively.

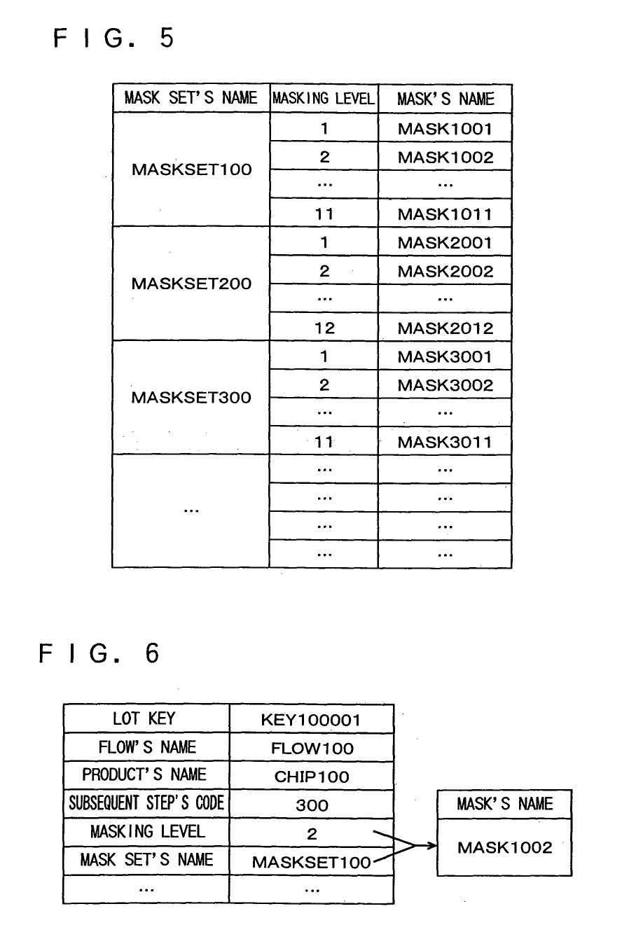

With reference to FIG. 6, the FIG. 2 lot information table 1206 will be described. As shown in the figure, table 1206 correlates a subsequent step's code, a masking level corresponding to the code, and a mask set's name to a lot key, a flow's name and a product's name, and stores them. The subsequent step's code is read and stored in accordance with the FIG. 4 table 1202 and the current step's code.

In connection with the masking level, when in the FIG. 4 process flow definition table 1202 the subsequent step's code represents a photography process step, a stored masking level is stored to lot information table 1206. As a mask set's name of lot information table 1206, a mask set's name corresponding to a product's name and a flow's name stored in the FIG. 3 basic production information table 1200 is stored. As shown in FIG. 6, based on a masking level and a mask set's name, from the FIG. 5 mask information definition table 1204 a mask's name can uniquely be determined.

Thus the semiconductor wafer production management device with the FIGS. 3-6 tables stored in fixed disk 124 is characterized in that a name of a mask used in a photography process is determined by a combination of a masking level and a mask set's name.

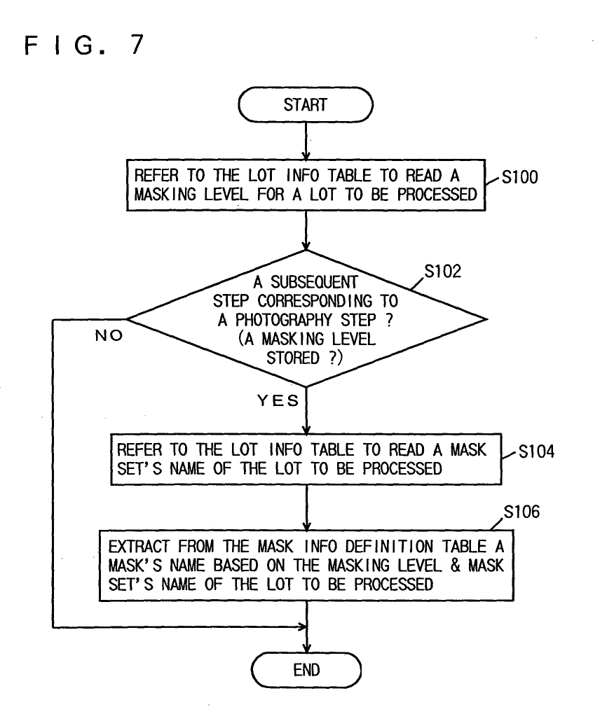

Reference will now be made to FIG. 7 to describe a control configuration of a program executed by CPU 120 of computer system 100 implementing the semiconductor wafer production management device.

At step (S)100 CPU 120 refers to lot information table 1206 (FIG. 6) to read a masking level for a lot to be processed. At S102 CPU 120 determines whether a subsequent step is a photolithography step. This decision is made by whether there is stored a masking level corresponding to the subsequent step's code in the FIG. 4 process flow definition table 1202. If the subsequent step is a photolithography step (YES at S102) then the control proceeds with S104. Otherwise (NO at S102) the process ends.

At S104 CPU 120 refers to lot information table 1206 (FIG. 6) to read a mask set's name for the lot to be processed. At S106 CPU 120 is driven by the masking level and mask set's name for the lot to extract a mask's name from mask information definition table 1204 (FIG. 5).

In accordance with the configuration and flow chart as described above the semiconductor wafer production management device of the present embodiment operates as described hereinafter.

In fixed disk 1204 the FIG. 3 basic production information table 1200, the FIG. 4 process flow definition table 1202 and the FIG. 5 mask information definition table 1204 are stored. Furthermore a lot key, a flow's name and a product's name in the FIG. 6 lot information table 1206 are stored. The lot key indicated in FIG. 6 specifies a production lot of a semiconductor wafer, which is processed in an order of steps represented by step codes of the FIG. 4 table 1202.

From a semiconductor wafer processing apparatus a lot key of a production lot processed in the apparatus is transmitted to computer system 100. This allows computer system 100 to understand for each lot key the corresponding production lot's current step's code.

If the control determines from the current step's code with reference to FIG. 4 process flow definition table 1202 that the subsequent step's code and the subsequent step are a photography process step, computer system 100 reads and writes a masking level to the FIG. 6 lot information table 1206. As such, a subsequent step's code and a masking level stored in lot information table 1206 are updated whenever a process flow defined in the FIG. 4 process flow definition table 1202 advances. Furthermore the FIG. 6 lot information table 1206 stores a mask set's name corresponding to a flow's name and a product's name.

In this condition when a manager instructs computer system 100 to effect a semiconductor wafer production management process, lot information table 1206 (FIG. 6) is referred to to read a masking level for a lot to be processed (S100). The FIG. 6 lot information table 1206 stores a masking level if a subsequent step is a photography process step. If a subsequent step is photography step, i.e., a masking level is stored (YES at S102) then lot information table 1206 (FIG. 6) is referred to to read a mask set's name for the lot to be processed (S104). Based on the lot's masking level and mask set's name, a mask's name is extracted from mask information definition table 1204 (FIG. 5).

In doing so, for example as shown in FIG. 6, if the masking level is “2” and the mask set's name is “MASKSET 100” then from the FIG. 5 mask information definition table 1204 a mask's name “MASK1200” is extracted.

Thus in the semiconductor wafer production management device of the present embodiment in introducing a subsequent step a lot key of the lot of interest is initially referred to to select a lot information table and a masking level is confirmed. If the subsequent step is a photolithography process step, then from the lot information table the masking level and mask set's name of interest are obtained and the obtained masking level and mask set's name are referred to to select from the mask information definition table a name of a mask that is required in the process for the lot to be processed at the photography step. This can implement a production management device more readily than conventional addressing processes including identical process steps in the same processing order, as required by semiconductor wafer production line, and employing different masks for photography process. The production management device as described above can help a production manager to work dramatically efficiently and it can also sufficiently endure frequent exchanges of masks.

### Second Embodiment

The present invention in a second embodiment provides a semiconductor wafer production management device as described hereinafter. The semiconductor wafer production management device of the present embodiment is implemented by a computer system identical to that implementing the semiconductor wafer production management device of the first embodiment.

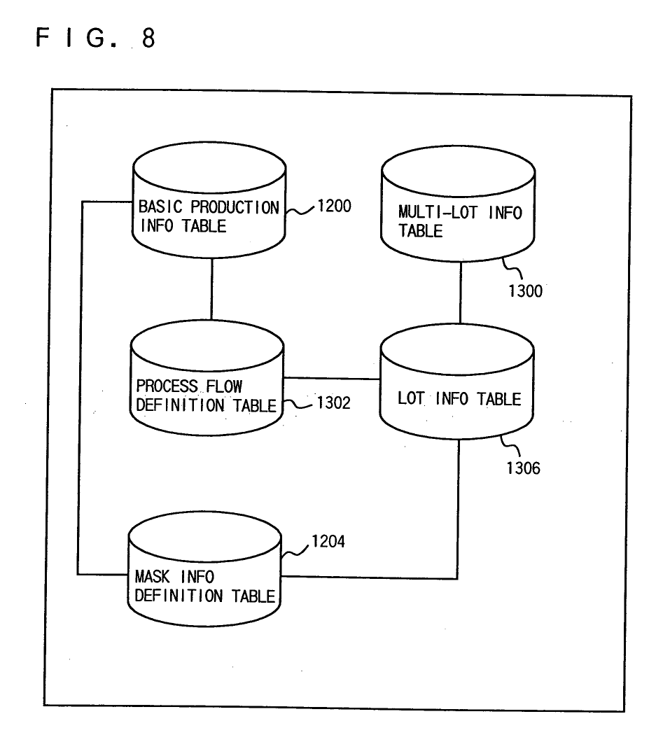

With reference to FIG. 8, the present embodiment provides a semiconductor wafer production management device implemented by computer system 100 including fixed disk 124 having a variety of tables stored therein. Note that the tables shown in FIG. 8 that are identical to those shown in FIG. 2 are denoted identically. Their internal configurations are also identical.

With reference to FIG. 8, fixed disk 124 stores a process flow definition table 1302 different from process flow definition table 1202 of the first embodiment, and a lot information table 1306 different from lot information table 1206. Furthermore, fixed disk 1204 stores a multi-lot information table 1300. These tables are correlated as shown in FIG. 8.

With reference to FIG. 9, the FIG. 8 process flow definition table 1302 will be described. As shown in the figure, table 1302 stores a flow's name, as correlated with a plurality of names of products, and a step code and a masking level that correspond to the flow's name. More specifically, as shown in FIG. 9, semiconductor wafers having product names “CHIP100,” “CHIP200,” “CHIP 300,” “CHIP 400” and “CHIP500” are all processed by a common process flow indicated by a name “FLOW100.” Accordingly, these semiconductor wafers can be carried by a single carrier and processed. Note that for a different product's name a photography step (e.g., step code” 200) employs a different type of mask.

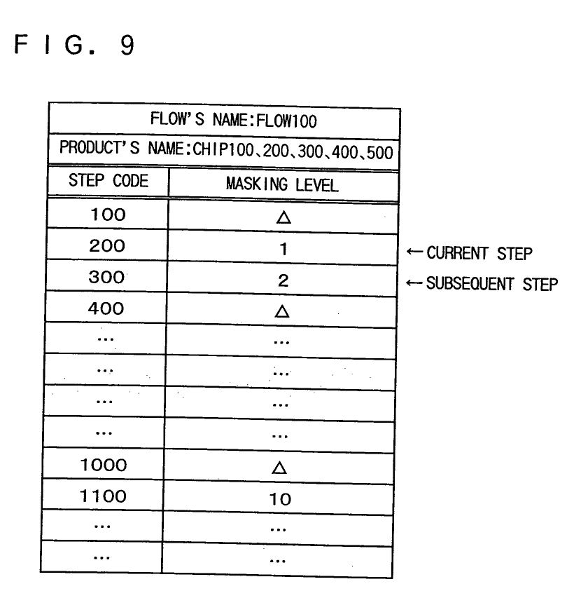

With reference to FIG. 10, the FIG. 8 multi-lot information table 1300 will be described. As shown in the figure, table 1300 stores for each carrier key lot keys representing a plurality of lots carried by the carrier. For example, as shown in the figure, a carrier indicated by a carrier key “CA1001” carries semiconductor wafers in production lots with “KEY100A” as a first lot key, “KEY100B” as a second lot key, “KEY100C” as a third lot key . . . .

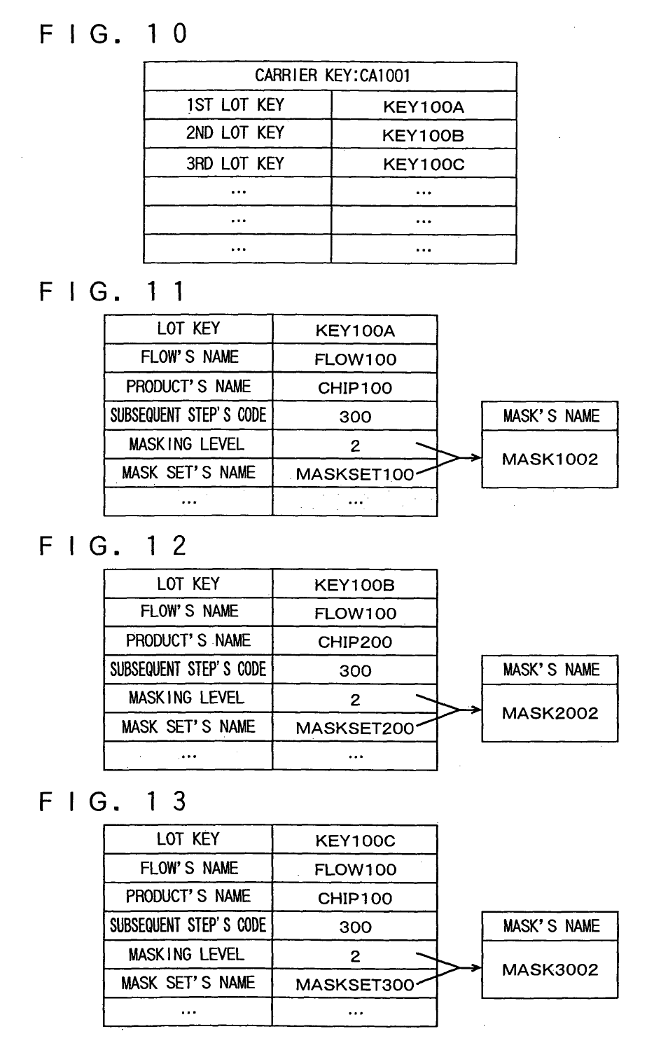

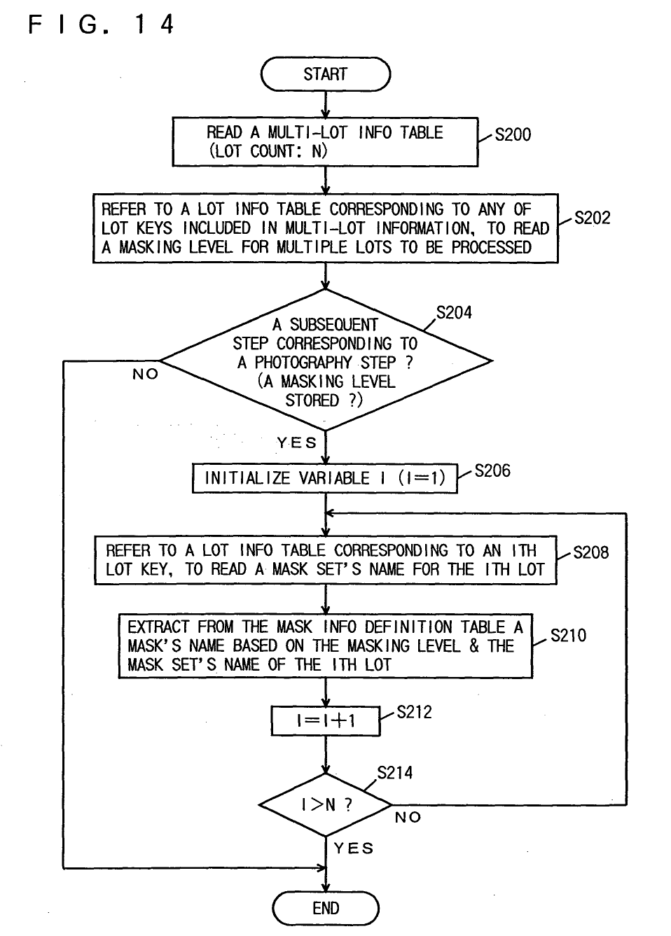

With reference to FIGS. 11-13, the FIG. 8 lot information table 1306 will be described. FIGS. 11, 12 and 13 show lot information table 1306 with lot keys corresponding to “KEY100A,” “KEY100B” and “KEY100C,” respectively. As shown in FIGS. 11-13, lot information table 1306 stores for each lot key representative of a production lot, each flow's name and each product's name a subsequent step's code, a masking level for the subsequent step's code representing a photolithography process step, and a mask set's name corresponding to the product's name. The mask set's name corresponding to the product's name is determined by the FIG. 3 basic information definition table 1200. As shown in FIGS. 11-13, in any lot information table 1306 a masking level and a mask set's name can be referred to to uniquely determine a mask's name.

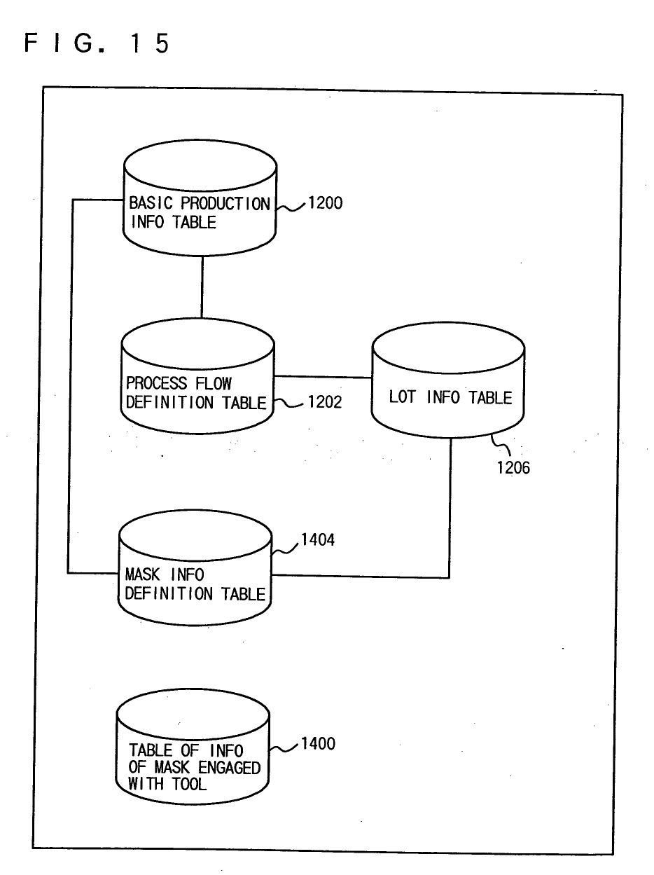

Reference will now be made to FIG. 14 to describe a control configuration of a program executed by CPU 120 of computer system 100 implementing the semiconductor wafer production management device of the present embodiment.

At S200 CPU 120 reads multi-lot information table 1300 (FIG. 10) from fixed disk 124. Table 1300 stores a lot count of N for the sake of illustration. At S2002 CPU120 refers to a lot information table (FIG. 11-13) corresponding to any of lot keys included in multi-lot information to read a masking level for multiple lots to be processed.

At S204 CPU 120 determines whether a subsequent step is a photography process step. If so (YES at S204) the control proceeds with S206. Otherwise (NO at S204) the process ends.

At S206 CPU 120 initializes a variable I (to 1). At S208 CPU120 refers to a lot information table (FIG. 11-13) corresponding to an Ith lot to read a mask set's name for the Ith lot. At S210 CPU 120 is driven by the masking level and the mask set's name for the Ith lot to extract a mask's name from mask information definition table 1204 (FIG. 5). Thus when the subsequent step is a photography process step a name of a mask to be used is determined.

At S212 CPU 120 increments variable I by one. At S214 CPU120 determines whether variable I is larger than lot count N. If so (YES at S214) the process ends. Otherwise (NO at S214) the control proceeds with S208 to extract a name of a mask for a photography process for a semiconductor wafer corresponding to a subsequent lot key. This process is effected for all of the production lots carried by a single carrier.

In accordance with the configuration and flow chart as described above, the semiconductor wafer production management device of the present embodiment operates, as described hereinafter.

Fixed disk 124 stores the FIG. 3 basic production information table 1200, the FIG. 9 process flow definition table 1302, the FIG. 5 mask information definition table 1204, and the FIGS. 11-13 lot information table 1306. Furthermore, the FIG. 10 multi-lot information table 1300 is previously stored in fixed disk 124.

When a manager instructs computer system 100 to effect a production management process for semiconductor wafers in multiple lots, multi-lot information table 1300 (FIG. 10) is read from fixed disk 124 (S200). A lot information table corresponding to any of lot keys included in multi-lot information is referred to to read a masking level for multiple lots to be processed (S202) and if a masking level is stored a decision is made that a subsequent step is a photography process step (YES at S204).

After variable I is initialized (S206) a lot information table (FIG. 11) corresponding to a first lot key is referred to to read a mask set's name for a first lot (S208). The masking level and the mask set's name for the first lot are referred to to extract a mask's name from mask information definition table 1204 (FIG. 5) (S210). In doing so, with reference to FIG. 11, if the masking level is “2” and the mask set's name is “MASKSET100” a mask's name “MASK1002” is extracted.

Variable I is incremented by one to be two (S212). Since variable I is smaller than the lot count (NO at S214), lot information table 1306 (FIG. 12) corresponding to a second lot key is referred to to read a mask set's name for a second lot (S208) and from mask information definition table 1204 (FIG. 5) a name of a mask for the second lot is extracted (S210). Such an operation is performed for all of the lots carried by a single carrier. By performing such a process, a name of a mask used in a photography process is extracted for each production lot carried by a single carrier, as shown in FIGS. 11-13.

Thus in the semiconductor wafer production management device of the present embodiment a mask information definition table and a multi-lot information table can be added to allow a selection of a mask for a photolithography process for multiple lots that has conventionally been effected by a manager manually. This allows an operator to work dramatically efficiently and can also prevent working errors so that a significantly reduced working time can be expected.

### Third Embodiment

The present invention in a third embodiment provides a semiconductor wafer production management device as described hereinafter. Note that the semiconductor wafer production management device of the present embodiment is implemented by the same computer system as implementing that of the first embodiment, as has been described in the second embodiment.

Reference will be made to FIG. 15 to describe tables stored in fixed disk 124 of computer system 100 implementing the semiconductor wafer production management device of the present embodiment. Note that the tables of FIG. 15 that are identical to those shown in FIGS. 2 and 8 are denoted identically. Their internal configurations are also identical.

With reference to FIG. 15, the semiconductor wafer production management system of the present embodiment is implemented by computer system 100 including fixed disk 124 storing a mask information definition table 1404 different from mask information definition tables 1204 and 1304 of the first and second embodiments, respectively, and a table 1400 of information of a mask engaged with a tool.

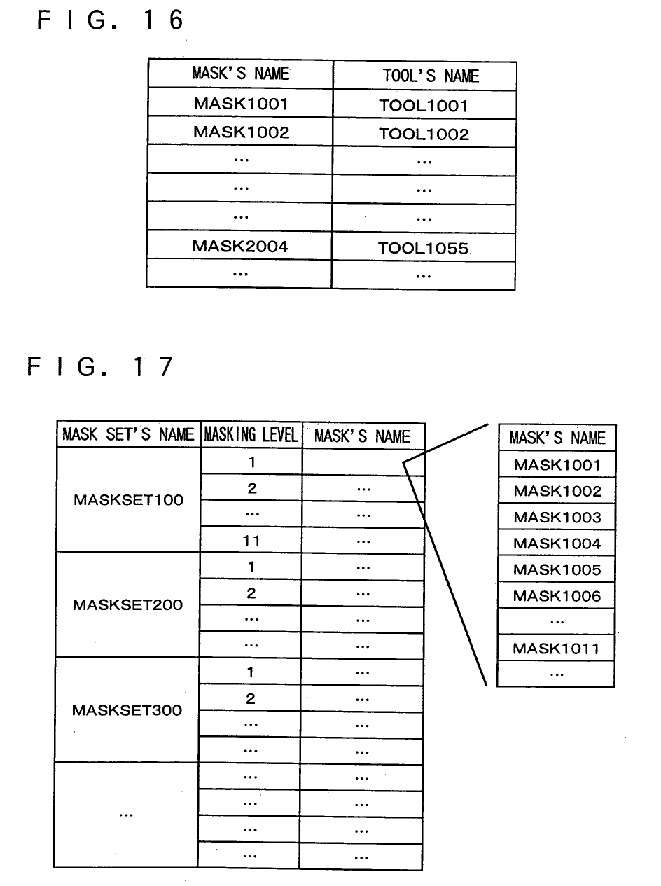

With reference to FIG. 16, the FIG. 15 table 1400 will be described. As shown in the figure, table 1400 stores for each mask's name a tool involved in a photography process and having engaged therewith a mask corresponding to the name. Since the FIG. 16 table 1400 stores only a name of a mask currently engaged with a tool involved in a photography process, the information is erased from table 1400 when the process involving the tool completes.

For example, as shown in FIG. 16, a mask specified by a name “MASK1002” is currently engaged with a photography tool specified by a name “TOOL1002.” As such, introducing into the photography tool specified by “TOOL2” a semiconductor wafer of a production lot associated with the mask specified by “MASK1002” can eliminate the necessity of exchanging the mask in the tool.

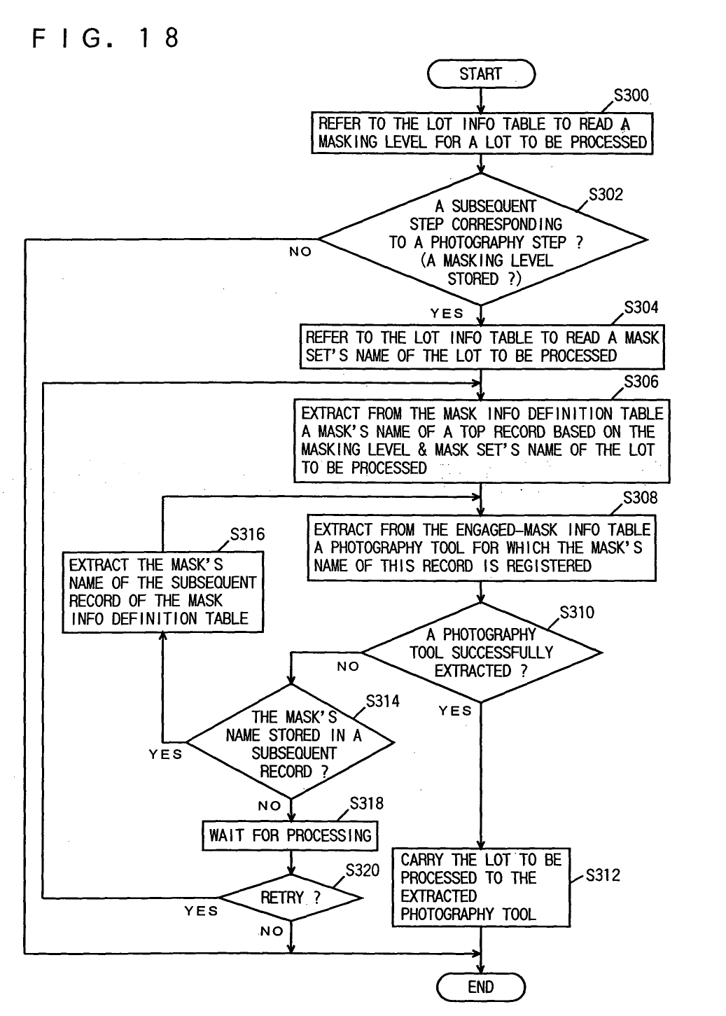

With reference to FIG. 17, the FIG. 15 mask information definition table 1404 will be described. As shown in the figure, mask information definition table 1404, in contrast to the FIG. 15 mask information definition table 1204 storing only a single mask's name, can store a plurality of names of masks. More specifically, for a mask set's name “MASKSET100” and a masking level of “1” a plurality of names of masks “MASK1001,” “MASK1002,” “MASK1003,” “MASK1004,” “MASK1005,” “MASK1006,” . . . “MASK1011,” . . . are stored. More specifically, the table stores that for a semiconductor wafer of a production lot corresponding to the mask set's name “MASKSET100” and the masking level “1” a mask having one of the plurality of names of masks shown in FIG. 17 is used.

Reference will now be made to FIG. 18 to describe a control configuration of a program executed by CPU 120 of computer system 100 implementing the semiconductor wafer production management device of the present embodiment.

Note that while the following description will not be provided in connection with multiple lots, the semiconductor wafer production management device of the present embodiment may manage multiple lots. In that case, a process is effected in conformity to the process described in the second embodiment.

At S300 CPU 120 refers to lot information table 1206 (FIG. 6) to read a masking level for a lot to be processed. At S302 CPU 120 determines whether a subsequent step is a photography process step. If so (YES at S302) the control proceeds with S304. Otherwise (NO at S302) the process ends.

At S304 CPU 120 refers to lot information table 1206 (FIG. 6) to read a mask set's name corresponding to the lot to be processed. At S306 CPU 120 is driven by the masking level and mask set's name corresponding to the lot to extract a mask name of a top record from mask information definition table 1404 (FIG. 17).

At S308 CPU 120 extracts from engaged-mask information table 1400 (FIG. 16) a photography tool for which the mask's name of this record is registered. At S310 CPU 120 determines whether a photography tool has successfully been extracted. If so (YES at S310) the control proceeds with S312. Otherwise (NO at S310) the control proceeds with S314.

At S312 CPU 120 issues an instruction to carry the lot to the extracted photography tool. The process then ends.

At S314 CPU 120 determines whether a subsequent record has a mask's name stored therein. If so (YES at S314) the control proceeds with S316. Otherwise (NO at S314) the control proceeds with S318.

At S316 CPU 120 extracts a mask's name of mask information definition table 1404 (FIG. 17). In doing so, the mask's name of the subsequent record is extracted. The control then proceeds with S308.

At S318 CPU 120 enters a wait state. At S320 CPU 120 determines whether to make a retry. If so (YES at S320) the control returns to S306. Otherwise (NO at S320) the process ends.

In accordance with the configuration and flow chart as described above the semiconductor wafer production management device of the present embodiment operates as described hereinafter.

A name of a mask engaged with a plurality of photography tools is transmitted to computer system 100 and stored to engaged-mask information table 1400 in fixed disk 124 (FIG. 16). When a manager instructs computer system 100 to effect a semiconductor wafer production management process, lot information table 1206 (FIG. 6) is referred to to read a masking level for a lot to be processed (S300) and if a masking level is stored a decision is made that a subsequent step is a photography process step (YES at S302). Lot information table 1206 (FIG. 6) is referred to to read a mask set's name for the lot to be processed (S304) and the masking level and mask set's name for the lot are referred to to extract a mask's name of a top record from mask information definition table 1404 (FIG. 17) (S306).

When from table 1400 (FIG. 16) a photography tool for which the mask's name of this record is registered can be extracted (YES at S310) an instruction is issued to carry the lot to the extracted photography tool (S312). By this instruction, a semiconductor wafer of a production lot undergoing a photography process employing the currently engaged mask is carried to the photography tool.

If any photography tool cannot be extracted (NO at S310) a decision is made as to whether a mask's name of a subsequent record is stored (S314) and if so then the mask's name of the subsequent record of mask information definition table 1404 (FIG. 17) is extracted (S316) and from table 1400 (FIG. 16) a photography tool for which the mask's name of this record is registered is extracted (S308).

If such a process performed for all records fails to extract a photography tool then the control temporarily enters a wait state (S318). In that state, the FIG. 16 table 1400 is updated in real time, and after the wait state if a decision is made to make a retry (YES at S320) then a decision is again made as to whether a mask specified by a mask's name in the FIG. 17 mask information definition table is engaged with a photography tool.

Thus by storing to a fixed disk a mask information definition table and a table of information of a mask engaged with a tool, different names of masks can be handled in a single photography process so that a photography tool can effectively be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor wafer production process management device comprising:
a storage portion including
a first table storing for each type of semiconductor wafer a process flow for said semiconductor wafer and a first mask identification code identifying a mask used in a masking step included in said process flow,
a second table storing for each type of semiconductor wafer a second mask identification code identifying a mask corresponding to said type of semiconductor wafer,
a third table storing a plurality of mask information items for each said second mask identification code, and
a fourth table storing a process flow and a type of semiconductor wafer for each semiconductor wafer production lot, said third table storing said plurality of mask information items correlated with said first mask identification code capable of identifying said mask information items;
a first select portion selecting from said second table said second mask identification code corresponding to a type of semiconductor wafer stored in said fourth table for each said production lot;
a detection portion detecting a current process step in said process flow for each said production lot;
an extraction portion referring to said first table and driven by said detected current process step to extract a subsequent step and extracting said first mask identification code for said masking step if the subsequent step is a masking step; and
a second select portion driven by said second mask identification code selected by said first select portion and said extracted first mask identification code to select said mask information item for said masking step from said third table.

2. The semiconductor wafer production process management device according to claim 1, wherein:
said first table is a process flow definition table;
said masking step is a photography process step;
as said first mask identification code a masking level is stored;
said second table is a basic production information table storing a mask set's name as said second mask identification code;
said third table is a mask information definition table storing a mask's name as said mask information item, more than one said mask's name being stored, as correlated with said masking level capable of identifying said more than one mask's name;
said fourth table is a lot information table;
said first select portion selects from said basic production information table a mask set's name corresponding to a type of semiconductor wafer stored in said lot information table for each said production lot;
said extraction portion refers to said process flow definition table and is also driven by said detected current process step to extract a subsequent step and extracts a masking level for said photography process step if the subsequent step is the photography process step; and
said second select portion is driven by a mask set's name selected by said first select portion and said extracted masking level to select a mask's name for said photography process step from said mask information definition table.

3. A semiconductor wafer production process management device, in the production process a plurality of production lots carried by a single carrier, the management device comprising:
a storage portion including
a first table storing for each type of semiconductor wafer a process flow for said semiconductor wafer and a first mask identification code identifying a mask used in a masking step included in said process flow,
a second table storing for each type of semiconductor wafer a second mask identification code identifying a mask corresponding to said type of semiconductor wafer,
a third table storing a plurality of mask information items for each said second mask identification code, and
a fourth table storing a process flow and a type of semiconductor wafer for each semiconductor wafer production lot, and
a fifth table storing a semiconductor wafer production lot carried by said carrier, said third table storing said plurality of mask information items correlated with said first mask identification code capable of identifying said mask information items;
a read portion reading from said fifth table a plurality of semiconductor wafer production lots carried by a single carrier;
a first select portion driven by a production lot read from said read portion to select from said second table said second mask identification code corresponding to a type of semiconductor wafer stored in said fourth table for each said production lot;
a detection portion detecting a current process step in said process flow for each carrier;
an extraction portion referring to said first table and driven by said detected current process step to extract a subsequent step and extracting said first mask identification code for said masking step if the subsequent step is a masking step; and
a second select portion driven by said second mask identification code selected by said first select portion and said extracted first mask identification code to select said mask information item for said masking step from said third table.

4. The semiconductor wafer production process management device according to claim 3, wherein:
said first table is a process flow definition table;
said masking step is a photography process step;
as said first mask identification code a masking level is stored;
said second table is a basic production information table storing a mask set's name as said second mask identification code;
said third table is a mask information definition table storing a mask's name as said mask information item, more than one said mask's name being stored, as correlated with said masking level capable of identifying said more than one mask's name;
said fourth table is a lot information table;
said fifth table is a multi-lot information table.
said first select portion selects from said basic production information table a mask set's name corresponding to a type of semiconductor wafer stored in said lot information table for each said production lot;
said extraction portion refers to said process flow definition table and is also driven by said detected current process step to extract a subsequent step and extracts a masking level for said photography process step if the subsequent step is the photography process step; and
said second select portion is driven by a mask set's name selected by said first select portion and said extracted masking level to select a mask's name for said photography process step from said mask information definition table.

5. The semiconductor wafer production process management device according to claim 2, said third table storing a plurality of masks' names as said mask information item, said semiconductor wafer production process management device further comprising a storage portion storing an engaged-mask information table storing a name of a mask currently engaged with a masking tool used in said masking step, wherein said second select portion is driven by a mask set's name selected by said first select portion and said extracted masking level to select a mask's name for said photography process step from said mask information definition table and selects a masking tool currently having engaged therewith a mask corresponding to said mask's name selected.

6. The semiconductor wafer production process management device according to claim 4, said third table storing a plurality of masks' names as said mask information item, said semiconductor wafer production process management device further comprising a storage portion storing an engaged-mask information table storing a name of a mask currently engaged with a masking tool used in said masking step, wherein said second select portion is driven by a mask set's name selected by said first select portion and said extracted masking level to select a mask's name for said photography process step from said mask information definition table and selects a masking tool currently having engaged therewith a mask corresponding to said mask's name selected.
